(19) United States
(12) Patent Application Publication
(10) Pub. No.: US 2024/0005770 A1
(43) Pub. Date: Jan. 4, 2024

(54) DISASTER INFORMATION PROCESSING APPARATUS, DISASTER INFORMATION PROCESSING SYSTEM, DISASTER INFORMATION PROCESSING METHOD, AND PROGRAM

(71) Applicant: FUJIFILM Corporation, Tokyo (JP)

(72) Inventor: Kyota WATANABE, Tokyo (JP)

(73) Assignee: FUJIFILM Corporation, Tokyo (JP)

(21) Appl. No.: 18/469,115

(22) Filed: Sep. 18, 2023

Related U.S. Application Data
(63) Continuation of application No. PCT/JP2022/010193, filed on Mar. 9, 2022.

(30) Foreign Application Priority Data
Mar. 19, 2021 (JP) 2021-046119

(51) Int. Cl. G08B 21/10; G06V 20/10; G06V 10/25; G06V 10/70

(52) U.S. Cl. CPC G08B 21/10; G06V 20/176; G06V 10/25; G06V 10/70

(57) ABSTRACT

Provided are a disaster information processing apparatus, a disaster information processing system, a disaster information processing method, and a program which extract and provide information on a building that has suffered from a disaster due to a specific disaster cause from an image including the building. An image including a building is acquired, a first disaster building that has suffered from a disaster due to a first disaster cause is extracted from the acquired image, the number of the extracted first disaster buildings is calculated, and at least a part of first disaster information, which is related to the extracted first disaster building and includes the calculated number of the first disaster buildings, is provided to a first terminal associated with the first disaster cause.

### CROSS-REFERENCE TO RELATED APPLICATIONS

The present application is a Continuation of PCT International Application No. PCT/JP2022/010193 filed on Mar. 9, 2022 claiming priority under 35 U.S.C § 119(a) to Japanese Patent Application No. 2021-046119 filed on Mar. 19, 2021. Each of the above applications is hereby expressly incorporated by reference, in its entirety, into the present application.

### BACKGROUND OF THE INVENTION

### 1. Field of the Invention

The present invention relates to a disaster information processing apparatus, a disaster information processing system, a disaster information processing method, and a program, and particularly relates to a technology for providing disaster information of a desired disaster cause.

### 2. Description of the Related Art

In a case in which a large-scale disaster, such as a large earthquake, occurs, a local government and the like is required to grasp a disaster situation early and accurately.

JP2017-220175A discloses a method of detecting a damaged house by using an image of an area in which a disaster occurs, which is captured from the sky and a house polygon acquired before the occurrence of the disaster.

### SUMMARY OF THE INVENTION

In an organization having jurisdiction over a specific disaster cause, it is required to acquire information on a building that has suffered from a disaster due to a disaster cause under its jurisdiction and information on a building that has suffered from a disaster due to a disaster cause outside the jurisdiction in a distinguished manner. For example, in a house damage survey during the disaster, a collapsed house, which is collapsed, is under the jurisdiction of the local government. On the other hand, a burned-down house, which is burned down by a fire, is generally under the jurisdiction of a fire station, and the damage survey and the issuance of a disaster certificate are performed under the control of the fire station. For this reason, it is required for the local government to exclude the burned-down house from a target in a case of formulating a damage survey plan. However, in a large-scale disaster, the collapsed house due to the earthquake and the burned-down house due to the fire coexist, and it is difficult to manually perform detection and totalization.

The present invention has been made in view of such circumstances, and is to provide a disaster information processing apparatus, a disaster information processing system, a disaster information processing method, and a program which extract and provide information on a building that has suffered from a disaster due to a specific disaster cause from an image including the building.

One aspect of a disaster information processing apparatus for achieving the above object is a disaster information processing apparatus comprising at least one processor, and at least one memory that stores a command to be executed by the at least one processor, in which the at least one processor acquires an image including a building, extracts a first disaster building that has suffered from a disaster due to a first disaster cause from the acquired image, calculates the number of the extracted first disaster buildings, and provides at least a part of first disaster information, which is related to the extracted first disaster building and includes the calculated number of the first disaster buildings, to a first terminal associated with the first disaster cause. According to the present aspect, it is possible to extract and provide the information on the building that has suffered from a disaster due to the specific disaster cause from the image including the building.

It is preferable that the at least one processor calculates the number of the extracted first disaster buildings for each area, and provides at least a part of the first disaster information for each area, which includes the number of the first disaster buildings calculated for each area to the first terminal. As a result, it is possible to provide the disaster information for each area.

It is preferable that the at least one processor acquires information on the first terminal for each area, which is associated with the first disaster cause, and provides at least a part of the first disaster information for each area to the first terminal associated with each area. As a result, it is possible to provide the disaster information for each area to the first terminal associated with each area.

It is preferable that the at least one processor displays the area on a display to be selectable by a user, and provides at least a part of the first disaster information on the area selected by the user to the first terminal associated with the area selected by the user. As a result, it is possible to provide the disaster information on a desired area to the first terminal associated with the desired area.

It is preferable that the at least one processor acquires area region information corresponding to the acquired image, and acquires the first disaster information for each area by using the acquired area region information. As a result, it is possible to appropriately acquire the disaster information for each area.

It is preferable that the at least one processor displays at least a part of the first disaster information on a display. As a result, it is possible for the user to visually recognize the disaster information.

It is preferable that the at least one processor acquires building region information corresponding to the acquired image, and extracts the building from the acquired image by using the acquired building region information. As a result, it is possible to appropriately extract the building from the image.

It is preferable that the at least one processor cuts out an image of a region of the building from the image, and discriminates whether or not the building of the cut out image is the first disaster building by inputting the cut out image of the region of the building to a first trained model, and the first trained model outputs, in a case in which the image of the building is given as input, whether or not a disaster cause of the building of the input image is the first disaster cause. As a result, it is possible to appropriately discriminate the building having the first disaster cause.

It is preferable that a second disaster building that has suffered from a disaster due to a second disaster cause different from the first disaster cause is extracted from the acquired image, the number of the extracted second disaster buildings is calculated, and at least a part of second disaster information, which is related to the extracted second disaster building and includes the calculated number of the second disaster buildings, is provided to a second terminal associated with the second disaster cause. As a result, it is possible to extract and provide the information on the building that has suffered from a disaster due to the second disaster cause different from the first disaster cause.

It is preferable that the at least one processor extracts each of disaster buildings that have suffered from a disaster due to each of a plurality of disaster causes from the acquired image, calculates the number of the extracted disaster buildings for each disaster cause, and provides at least a part of disaster information for each disaster cause, which is related to the extracted disaster building and includes the calculated number of the disaster buildings for each disaster cause, to a third terminal which is different from the first terminal and is associated with each disaster cause. As a result, it is possible to extract the information on each of the buildings that have suffered from a disaster due to the plurality of disaster causes from the image including the building, and to provide the information to the third terminal.

It is preferable that the at least one processor discriminates whether or not the building included in the image has suffered from a disaster, and extracts the disaster building that has suffered from a disaster due to each disaster cause from the building discriminated as having suffered from a disaster. As a result, it is possible to extract the information on the building that has suffered from a disaster without omission.

It is preferable that the at least one processor cuts out an image of a region of the building from the image, and acquires whether or not the building of the cut out image has suffered from a disaster by inputting the cut out image of the region of the building to a second trained model, and the second trained model outputs, in a case in which the image of the building is given as input, whether or not the building of the input image has suffered from a disaster. As a result, it is possible to appropriately extract the building that has suffered from a disaster.

It is preferable that the first disaster cause is a fire, and the first terminal is associated with a fire station. As a result, it is possible to provide the information on the building that has suffered from a disaster due to the fire to the fire station having jurisdiction over the fire.

It is preferable that the image is an aerial image captured from a flying object or a satellite image captured from an artificial satellite. As a result, it is possible to acquire the disaster information on the plurality of buildings from one image.

One aspect of a disaster information processing system for achieving the above object is a disaster information processing system comprising a first terminal including at least one first processor, and at least one first memory that stores a command to be executed by the at least one first processor, a server including at least one second processor, and at least one second memory that stores a command to be executed by the at least one second processor, and a fourth terminal including at least one third processor, and at least one third memory that stores a command to be executed by the at least one third processor, in which the at least one third processor acquires an image including an building, extracts an image of a region of the building from the acquired image, and provides the extracted image of the region of the building to the server, the at least one second processor acquires the image of the region of the building provided from the fourth terminal, extracts a first disaster building that has suffered from a disaster due to a first disaster cause from the acquired image of the region of the building, calculates the number of the extracted first disaster buildings, and provides at least a part of first disaster information, which is related to the extracted first disaster building and includes the calculated number of the first disaster buildings, to the first terminal, and the at least one first processor acquires at least a part of the first disaster information provided from the server, and displays at least a part of the first disaster information on a first display. According to the present aspect, it is possible to extract and provide the information on the building that has suffered from a disaster due to the specific disaster cause from the image including the building.

One aspect of a disaster information processing method for achieving the above object is a disaster information processing method comprising an image acquisition step of acquiring an image including a building, a first disaster building extraction step of extracting a first disaster building that has suffered from a disaster due to a first disaster cause from the acquired image, a calculation step of calculating the number of the extracted first disaster buildings, and a providing step of providing at least a part of first disaster information, which is related to the extracted first disaster building and includes the calculated number of the first disaster buildings, to a first terminal associated with the first disaster cause. According to the present aspect, it is possible to extract and provide the information on the building that has suffered from a disaster due to the specific disaster cause from the image including the building.

One aspect of a program for achieving the above object is a program causing a computer to execute the disaster information processing method described above. A computer-readable non-transitory recording medium on which the program is recorded may also be included in the present aspect.

According to the present invention, it is possible to extract and provide the information on the building that has suffered from a disaster due to the specific disaster cause from the image including the building.

### BRIEF DESCRIPTION OF THE DRAWINGS

FIG. 1 is a schematic diagram of a disaster information processing system.

FIG. 2 is a block diagram of the disaster information processing system.

FIG. 3 is a functional block diagram of the disaster information processing system.

FIG. 4 is a flowchart showing each step of a disaster information processing method.

FIG. 5 is a process diagram of each step of the disaster information processing method.

FIG. 6 is a process diagram of disaster information processing for each area.

FIG. 7 is a process diagram of processing of giving a notification to a fire station having jurisdiction.

FIG. 8 is a process diagram of processing of sorting a collapsed house, a burned-down house, and an inundated house.

FIG. 9 is a process diagram of processing of sorting the collapsed house and the inundated house.

### DESCRIPTION OF THE PREFERRED EMBODIMENTS

Hereinafter, the detailed description of a preferred embodiment of the present invention will be made with reference to the accompanying drawings.

[Entire Configuration of Disaster Information Processing System]

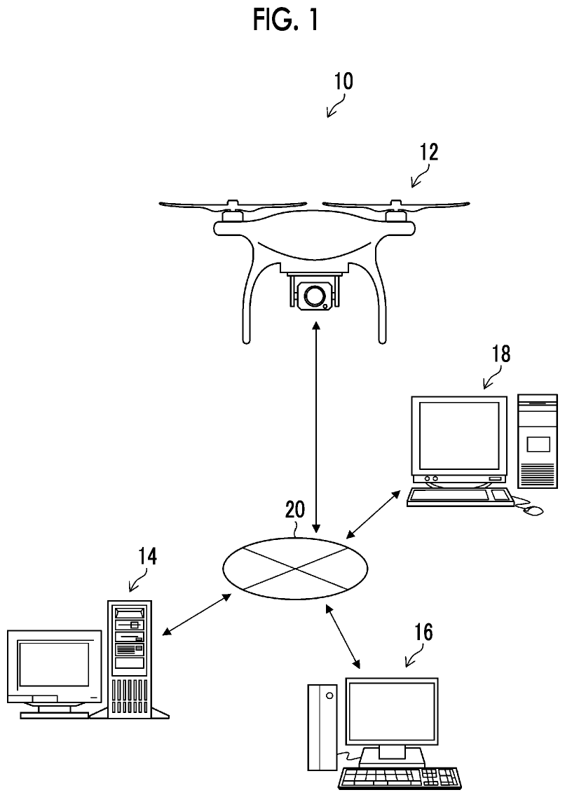

FIG. 1 is a schematic diagram of a disaster information processing system 10 according to the present embodiment. As shown in FIG. 1, the disaster information processing system 10 includes a drone 12, a local government server 14, a fire station terminal 16, and a local government terminal 18.

The drone 12 (an example of a “fourth terminal”) is an unmanned aerial vehicle (UAV, an example of a “flying object”) that is remotely operated by the local government server 14 or a controller (not shown). The drone 12 may have an auto-pilot function of flying according to a predetermined program. The drone 12 images the ground from the sky, for example, in a case in which a large-scale disaster occurs, and acquires an aerial image (high-altitude image) including a building. The building refers to a house, such as a “detached house” and an “apartment house”, but may include a whole building, such as a “store”, an “office”, and a “factory”. Hereinafter, the building will be referred to as “house” without distinguishing the types.

The local government server 14 is installed in a department that is located in an office of the local government and is involved in a house damage certification survey. The local government server 14 is implemented by at least one computer, and constitutes a disaster information processing apparatus. The local government server 14 may be a cloud server provided by a cloud system.

The fire station terminal 16 is installed in a fire station which is an organization that has jurisdiction over a fire (an example of a “first disaster cause”) and is associated with the local government in which the local government server 14 is installed. The fire station terminal 16 (an example of a “first terminal”) is implemented by at least one computer, and constitutes the disaster information processing apparatus.

The local government terminal 18 is installed in a department that is located in the office of the local government and is different from the department in which the local government server 14 is installed. The local government terminal 18 is implemented by at least one computer, and is connected to a communication network 20. The local government terminal 18 may be installed in a branch office of the local government.

The drone 12, the local government server 14, the fire station terminal 16, and the local government terminal 18 are connected to each other via the communication network 20, such as a 2.4 GHz band wireless local area network (LAN) so that data can be transmitted and received.

It should be noted that the drone 12, the local government server 14, the fire station terminal 16, and the local government terminal 18 need only be able to exchange the data, and do not have to be directly connected to each other so that the data can be transmitted and received. For example, the data may be exchanged via a data server (not shown).

[Electric Configuration of Disaster Information Processing System]

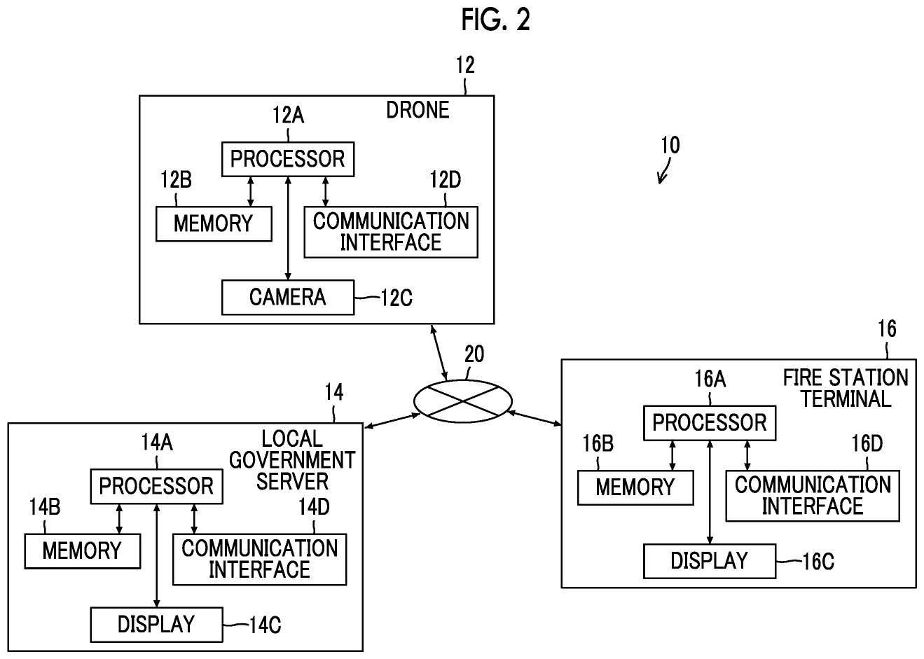

FIG. 2 is a block diagram showing an electric configuration of the disaster information processing system 10. As shown in FIG. 2, the drone 12 includes a processor 12A, a memory 12B, a camera 12C, and a communication interface 12D.

The processor 12A (an example of a “third processor”) executes a command stored in the memory 12B. A hardware structure of the processor 12A is various processors as shown below. Various processors include a central processing unit (CPU) as a general-purpose processor which acts as various function units by executing software (program), a graphics processing unit (GPU) as a processor specialized in image processing, a programmable logic device (PLD) as a processor of which a circuit configuration can be changed after manufacture, such as a field programmable gate array (FPGA), a dedicated electric circuit as a processor which has a circuit configuration specifically designed to execute specific processing, such as an application specific integrated circuit (ASIC), and the like.

One processing unit may be configured by using one of these various processors, or may be configured by using two or more processors of the same type or different types (for example, a plurality of FPGAs, or a combination of a CPU and an FPGA, or a combination of a CPU and a GPU). Moreover, a plurality of function units may be configured by using one processor. As a first example in which the plurality of function units are configured by using one processor, as represented by a computer such as a client or a server, there is a form in which one processor is configured by using a combination of one or more CPUs and software, and this processor acts as the plurality of function units. As a second example thereof, as represented by a system on chip (SoC), there is a form in which a processor, which implements the functions of the entire system including the plurality of function units by one integrated circuit (IC) chip, is used. As described above, various function units are configured by using one or more of the various processors described above as the hardware structure.

Further, the hardware structure of these various processors is, more specifically, an electric circuit (circuitry) in which circuit elements, such as semiconductor elements, are combined.

The memory 12B (an example of a “third memory”) stores the command to be executed by the processor 12A. The memory 12B includes a random access memory (RAM) and a read only memory (ROM)(which are not shown). The processor 12A executes various types of processing of the drone 12 by using the RAM as a work region, executing software by using various programs and parameters stored in the ROM, and using the parameters stored in the ROM and the like.

The camera 12C comprises a lens (not shown) and an imaging element (not shown). The camera 12C is supported by the drone 12 via a gimbal (not shown). The lens of the camera 12C images received subject light on an imaging plane of the imaging element. The imaging element of the camera 12C receives the subject light imaged on the imaging plane, and outputs an image signal of a subject.

The camera 12C may acquire angles of a roll axis, a pitch axis, and a yaw axis of an optical axis of the lens by a gyro sensor (not shown).

The communication interface 12D controls communication via the communication network 20.

The drone 12 may comprise a global positioning system (GPS) receiver (not shown), an atmospheric pressure sensor, a direction sensor, a gyro sensor, and the like.

In addition, as shown in FIG. 2, the local government server 14 includes a processor 14A, a memory 14B, a display 14C, and a communication interface 14D. The fire station terminal 16 includes a processor 16A, a memory 16B, a display 16C, and a communication interface 16D.

The configurations of the processor 14A (an example of a “second processor”) and the processor 16A (an example of a “first processor”) are the same as the configuration of the processor 12A. In addition, the configurations of the memory 14B (an example of a “second memory”) and the memory 16B (an example of a “first memory”) are the same as the configuration of the memory 12B.

The display 14C is a display device for allowing a staff (user) of the local government to visually recognize the information processed by the disaster information processing system 10. A large-screen plasma display, a multi-sided multi-display in which a plurality of displays are connected, and the like can be applied as the display 14C. In addition, the display 14C includes a projector that projects an image on a screen.

The display 16C (an example of a “first display”) is a display device for allowing a staff of the fire station to visually recognize the information processed by the disaster information processing system 10. The configuration of the display 16C is the same as the configuration of the display 14C.

The configurations of the communication interface 14D and the communication interface 16D are the same as the configuration of the communication interface 12D.

In addition, although not shown in FIG. 2, the configuration of the local government terminal 18 is the same as the configuration of the fire station terminal 16.

[Functional Configuration of Disaster Information Processing System]

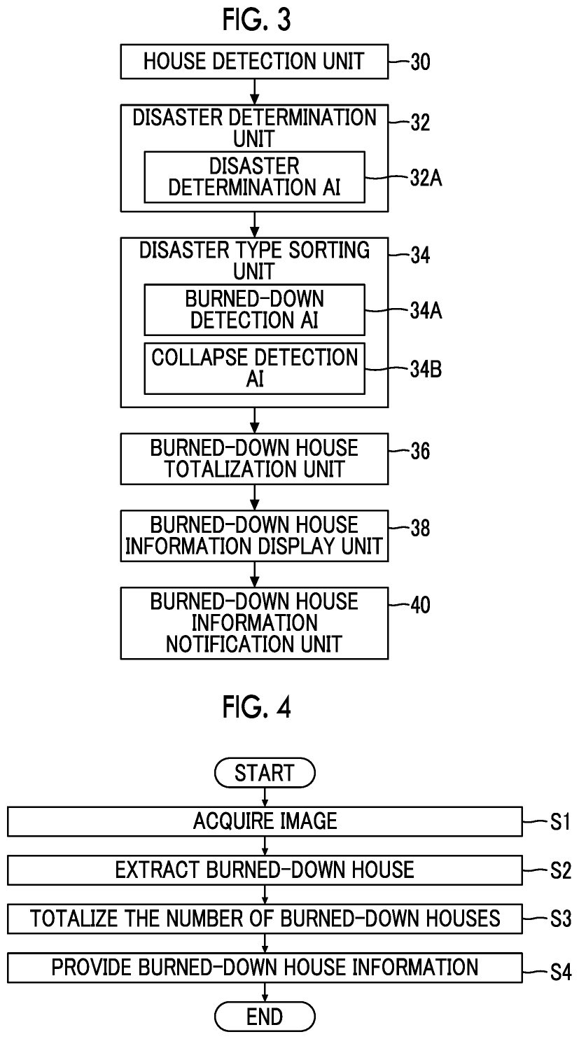

FIG. 3 is a functional block diagram of the disaster information processing system 10. As shown in FIG. 3, the disaster information processing system 10 comprises a house detection unit 30, a disaster determination unit 32, a disaster type sorting unit 34, a burned-down house totalization unit 36, a burned-down house information display unit 38, and a burned-down house information notification unit 40.

A function of the house detection unit 30 is implemented by the processor 12A. In addition, functions of the disaster determination unit 32, the disaster type sorting unit 34, the burned-down house totalization unit 36, the burned-down house information display unit 38, and the burned-down house information notification unit 40 are implemented by the processor 14A. All of these functions may be implemented by any of the processor 12A or the processor 14A. In addition, the disaster information processing system 10 may be interpreted as a “disaster information processing apparatus” implemented by a plurality of processors.

The house detection unit 30 detects a region of a house included in the high-altitude image acquired from the camera 12C, cuts out each of the detected regions of the house, and generates a house cutout image. The house detection unit 30 detects the region of the house from the high-altitude image and house region information (an example of “building region information”) of the area captured by the high-altitude image. The house region information is information including at least one of boundary line information on the house, positional information on the house, or address information on the house. The boundary line information on the house may be polygon information. The polygon information on the house is generated from outer peripheral shape data of the house, height data of the house, and altitude data of the land. The positional information on the house includes information on the latitude and the longitude. The address information on the house includes information on prefecture, city, ward, town, village, district, block, and address number. The house region information is stored in the memory 12B.

The disaster determination unit 32 determines (discriminates) whether or not the house included in the house cutout image has suffered from a disaster. The fact that the house has suffered from a disaster means that the damage to the house occurs due to the disaster. The disaster determination unit 32 comprises a disaster determination artificial intelligence (AI) 32A.

The disaster determination AI 32A (an example of a “second trained model”) is a trained model that outputs whether or not the house included in the house cutout image has suffered from a disaster in a case in which the house cutout image is given as input. The disaster determination AI 32A is subjected to machine learning using a training data set for training including the house cutout image in which the region of the house is cut out and the presence or absence of the disaster of the house included in the house cutout image as a set. A convolution neural network (CNN) can be applied to the disaster determination AI 32A.

The disaster type sorting unit 34 sorts the disaster type of the house in the house cutout image in which it is determined that the house has suffered from a disaster, extracts a burned-down house (an example of a “first disaster building”) that has suffered from a disaster due to a fire (an example of a “first disaster cause”) from the house cutout image, and extracts a collapsed house (an example of a “second disaster building”) that has suffered from a disaster due to a collapse (an example of a “second disaster cause”) from the house cutout image.

The disaster type sorting unit 34 comprises a burned-down detection AI 34A and a collapse detection AI 34B. The burned-down detection AI 34A (an example of a “first trained model”) is a trained model that outputs whether or not the house included in the house cutout image is burned down in a case in which the house cutout image is given as input. The fact that the house is burned down means that the damage to the house occurs due to the fire, and is not limited to a case of “entirely burned”, and includes “half burned”, “partially burned”, and “slightly burned”. The burned-down detection AI 34A is subjected to machine learning using a training data set for training including the house cutout image in which the region of the house is cut out and the presence or absence of burning down of the house included in the house cutout image as a set.

The collapse detection AI 34B is a trained model that outputs whether or not the house included in the house cutout image is collapsed in a case in which the house cutout image is given as input. The fact that the house is collapsed means that the house is destroyed, and is not limited to a case of “entirely destroyed” and includes “large-scale partial destroyed” and “half destroyed”. The collapse detection AI 34B is subjected to machine learning using a training data set for training including the house cutout image in which the region of the house is cut out and the presence or absence of the collapsed of the house included in the house cutout image as a set. A convolution neural network can be applied to the burned-down detection AI 34A and the collapse detection AI 34B.

The burned-down house totalization unit 36 totalizes (an example of “calculation”) the number of houses (burned-down houses) that are determined by the disaster type sorting unit 34 that the house is burned down.

The burned-down house information display unit 38 displays at least a part of disaster information, which is related to the burned-down house sorted by the disaster type sorting unit 34 and includes the number of burned-down houses totalized by the burned-down house totalization unit 36, on the display 14C. The disaster information includes at least one of the image of the burned-down house, the positional information, or the address information.

The burned-down house information notification unit 40 notifies (an example of “providing”) the fire station terminal 16 associated with the fire of at least a part of the disaster information (an example of “first disaster information”), which is related to the burned-down house sorted by the disaster type sorting unit 34 and includes the number of burned-down houses totalized by the burned-down house totalization unit 36.

It should be noted that, in the disaster information processing system 10, it is sufficient that the local government server 14 can provide the disaster information to the fire station terminal 16, and the local government server 14 does not always have to directly notify the fire station terminal 16 of the disaster information. For example, the local government server 14 may upload the disaster information to a server (not shown), and the fire station terminal 16 may download the disaster information from the server (not shown).

[Disaster Information Processing Method]

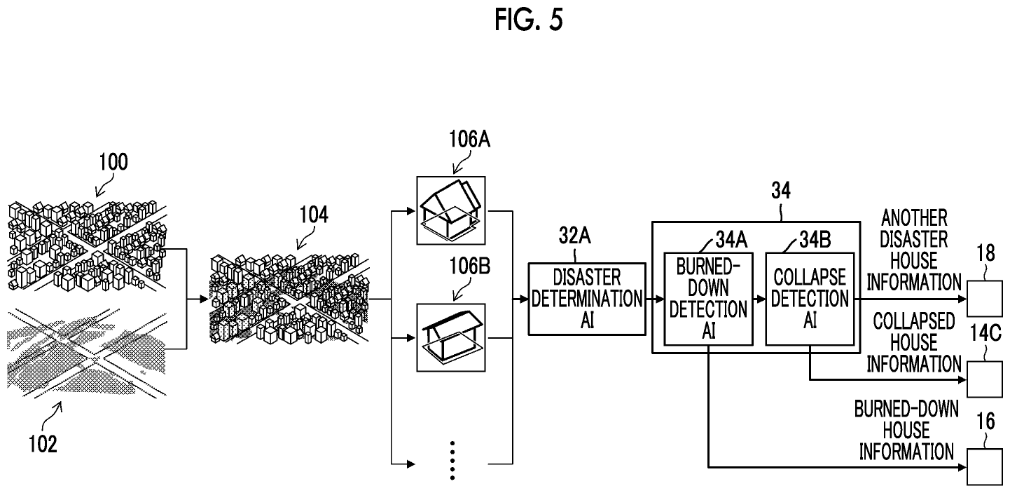

FIG. 4 is a flowchart showing each step of a disaster information processing method using the disaster information processing system 10. In addition, FIG. 5 is a process diagram of each step of the disaster information processing method. The disaster information processing method is implemented by executing a disaster information processing program stored in the memory 14B by the processor 14A. The disaster information processing program may be provided by a computer-readable non-transitory recording medium. In this case, the local government server 14 may read the disaster information processing program from the non-transitory recording medium, and may store the disaster information processing program in the memory 14B.

In step S1 (an example of an “image acquisition step”), the drone 12 flies over the sky over the city immediately after the large-scale disaster according to an instruction from the local government server 14, and captures the high-altitude image including the house by the camera 12C.

In step S2 (an example of a “first disaster building extraction step”), the disaster information processing system 10 extracts the burned-down house (an example of a “first disaster house”) from the high-altitude image. First, the house detection unit 30 of the processor 12A of the drone 12 detects the region of the house from the high-altitude image captured in step S1 based on the house region information acquired from the memory 12B.

FIG. 5 shows a high-altitude image 100 and house region information 102 at the same angle as the high-altitude image 100. The house region information 102 is information created from the high-altitude image captured before the occurrence of the large-scale disaster, and is information indicating an outer peripheral shape of the house as a line here.

In addition, FIG. 5 shows a composite image 104 in which the high-altitude image 100 and the house region information 102 are combined. By generating such a composite image 104, the house detection unit 30 can recognize that the region surrounded by the line of the house region information 102 in the composite image 104 is the house.

The house detection unit 30 cuts out each region of the house detected by the composite image 104 from the high-altitude image 100 to generate the house cutout image.

House cutout images 106A, 106B, . . . are shown in FIG. 5. The house cutout images are generated for the number of detected houses.

The drone 12 transmits (an example of “providing”) the house cutout images 106A, 106B, . . . to the local government server 14 via the communication network 20 by the communication interface 12D. The local government server 14 receives (an example of “acquisition”) the house cutout images 106A, 106B, . . . by the communication interface 14D.

Next, the disaster determination unit 32 of the processor 14A of the local government server 14 sequentially inputs a plurality of house cutout images to the disaster determination AI 32A, and determines whether or not each house included in each of the house cutout images has suffered from a disaster. That is, the disaster determination unit 32 sorts the house cutout image in which the house has suffered from a disaster and the house cutout image in which the house is not suffered from a disaster among the plurality of house cutout images. FIG. 5 shows an example in which the house cutout images 106A, 106B, . . . are input to the disaster determination AI 32A.

Subsequently, the disaster type sorting unit 34 sequentially inputs the house cutout image in which it is determined by the disaster determination unit 32 that the house has suffered from a disaster among the plurality of house cutout images to the burned-down detection AI 34A, and determines whether or not each house included in each of the house cutout images is burned down. That is, the burned-down detection AI 34A sorts the house cutout image in which the house is burned down and the house cutout image in which the house is not burned down.

In addition, the disaster type sorting unit 34 sequentially inputs the house cutout images in which it is determined by the disaster determination unit 32 that the house has suffered from a disaster and it is determined by the burned-down detection AI 34A that the house is not burned down among the plurality of house cutout images to the collapse detection AI 34B, and determines whether or not each house included in each of the house cutout images is collapsed. That is, the collapse detection AI 34B sorts the house cutout image in which the house is collapsed and the house cutout image in which the house is not collapsed.

In this way, in the disaster type sorting unit 34, among the plurality of house cutout images in which the house has suffered from a disaster, the house cutout image in which the house is burned down, the house cutout image in which the house is collapsed, and the house cutout image of the disaster other than burning down and the collapse are sorted. Therefore, the disaster information processing system 10 can extract the burned-down house from the high-altitude image. FIG. 5 shows an example in which the house cutout image is input to the burned-down detection AI 34A and the collapse detection AI 34B.

Here, in the disaster type sorting unit 34, it is determined whether or not the house is collapsed after it is determined whether or not the house is burned down, but the order of sorting the burned-down house and the collapsed house may be reversed. That is, the disaster type sorting unit 34 may determine whether or not the house is burned down after determining whether or not the house is collapsed.

In addition, the disaster determination unit 32 determines whether or not the house included in the house cutout image has suffered from a disaster, and the disaster type sorting unit 34 sorts the disaster type for the house cutout image in which it is determined that the house has suffered from a disaster. However, the processing of the disaster determination unit 32 and the disaster type sorting unit 34 may be reversed. That is, the disaster type sorting unit 34 may sort the disaster type of the house included in the house cutout image, and the disaster determination unit 32 may determine whether or not the house has suffered from a disaster for the house cutout image that is not sorted in any of the cases.

Next, in step S3 (an example of a “calculation step”), the burned-down house totalization unit 36 totalizes the number of burned-down houses included in the high-altitude image. The number of burned-down houses corresponds to the number of house cutout images in which it is determined in the processing of the burned-down detection AI 34A in step S2 that the house is burned down. The burned-down house totalization unit 36 may totalize the number of collapsed houses (an example of a “second disaster house”) included in the high-altitude image together with the totalization of the number of burned-down houses.

Finally, in step S4 (an example of a “providing step”), the burned-down house information notification unit 40 notifies the fire station terminal 16 of the disaster information (an example of “first disaster information”) related to the burned-down house extracted in step S2 by using the communication interface 14D. The disaster information includes the number of burned-down houses totalized in step S3. The burned-down house information notification unit 40 may notify the fire station terminal 16 of at least a part of the disaster information.

The burned-down house information display unit 38 may display at least a part of the disaster information on the display 14C. The burned-down house information notification unit 40 may notify the local government terminal 18 (an example of a “second terminal”) of at least a part of the disaster information (an example of “second disaster information”) that is related to the collapsed house discriminated in step S2 and includes the number of collapsed houses totalized in step S3. The burned-down house information display unit 38 may display at least a part of this disaster information on the display 14C.

The processor 16A of the fire station terminal 16 receives the disaster information transmitted from the burned-down house information notification unit 40 by using the communication interface 16D, and displays the disaster information on the display 16C. As a result, the staff of the fire station can visually recognize the information on the burned-down house included in the high-altitude image.

In addition, the processor 14A of the local government server 14 may display at least a part of the disaster information, which is related to the collapsed house discriminated in step S2 and includes the number of collapsed houses totalized in step S3, on the display 14C. Further, the processor 14A of the local government server 14 may display at least a part of the disaster information of the house having the disaster cause other than the burning down and the collapse on the display 14C, or may provide at least a part of the disaster information to the local government terminal 18.

As described above, with the disaster information processing system 10, it is possible to extract the information on the house that has suffered from a disaster due to the fire from the high-altitude image including the house, and provide the information to the fire station having jurisdiction over the fire. In addition, with the disaster information processing system 10, it is possible to extract the information on the house that has suffered from a disaster due to the collapse from the high-altitude image including the house, and provide the information to the department of the local government having jurisdiction over the collapse. Further, since it is possible to extract the information on the house having the disaster cause other than the fire and the collapse from the high-altitude image including the house and to provide the information to the department of the local government having jurisdiction over the disaster cause other than the fire and the collapse, it is possible to provide the information on the house that has suffered from a disaster without omission.

[Disaster Information Processing Method for Each Area]

The disaster information processing method may be performed for each area. For example, the burned-down house totalization unit 36 may totalize the number of burned-down houses for each area, the burned-down house information display unit 38 may display the information on the burned-down house for each area, and the burned-down house information notification unit 40 may notify the fire station terminal 16 for each area of the disaster information for each area. Each area may be each of city, ward, town, and village, may be each district, or may be each block.

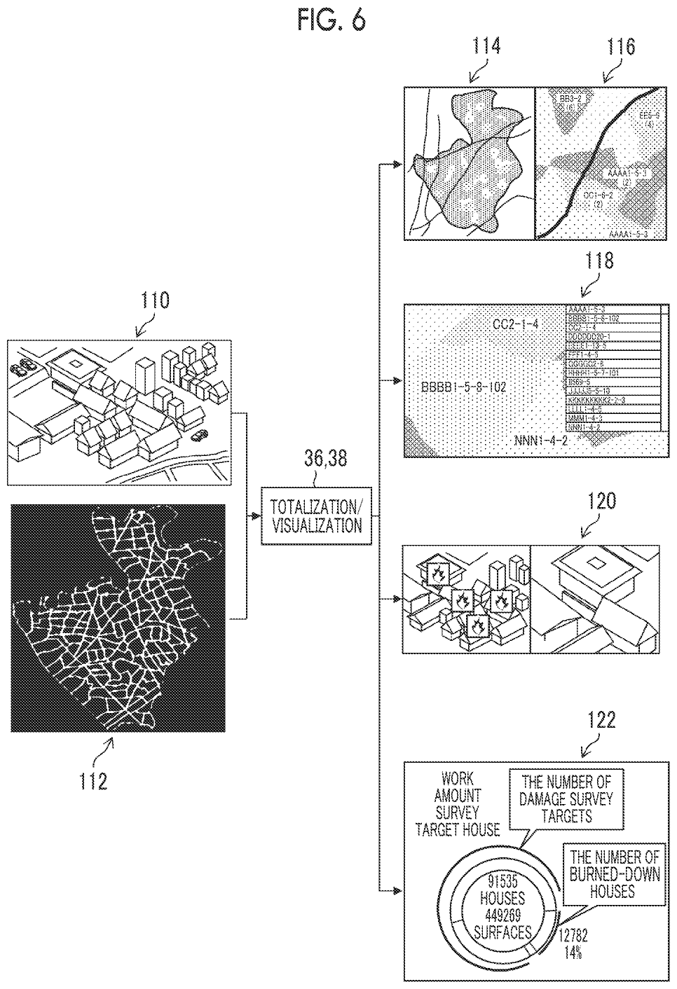

FIG. 6 is a process diagram of the disaster information processing for each area. FIG. 6 shows burned-down house information 110 in a certain area and block region information 112. The burned-down house information 110 includes at least one of the image of the burned-down house, the positional information, or the address information. In addition, the block region information 112 is an example of area region information corresponding to the high-altitude image including the burned-down house of the burned-down house information 110, and is the block region information representing the boundary line constituting each block by a white line here.

The burned-down house totalization unit 36 performs totalization processing for each block using the block region information 112. In a case in which the burned-down house information 110 does not include the address information, the boundary line information is used to determine and totalize which block the burned-down house is included in.

FIG. 6 shows, as an example of situation grasping information displayed on the display 14C by the burned-down house information display unit 38, totalization results 114 and 116 for each block, an address list 118 of the burned-down house, the house cutout image 120, and estimation 122 of the work amount of the house damage certification survey.

The totalization result 114 is a map of the area, and the regions of the blocks are displayed in different colors according to the number of burned-down houses in each block. For example, the burned-down house information display unit 38 displays the block with a relatively large number of burned-down houses in red and the block with a relatively small number of burned-down houses in blue. The burned-down house information display unit 38 may further display, for each color region, a higher density as the number of burned-down houses is relatively larger.

The totalization result 116 is a map on which a part of the totalization result 114 is enlarged. In the totalization result 116, a name of the block and the number of burned-down houses in each block are displayed.

The address list 118 is a list of the addresses of the burned-down houses included in the block selected by the user from the displayed map.

The house cutout image 120 is, for example, the image of the burned-down house included in the block selected by the user from the high-altitude image. The house cutout image 120 may be the image of the burned-down house selected by the user from the address list 118.

The estimation 122 includes the totalization result of the number of burned-down houses included in the block selected by the user from the displayed map and the number of local government survey target houses. In the example shown in FIG. 6, the number of survey target houses is 91535 houses (449269 surfaces), the number of burned-down houses among the number of survey target houses is 12782 houses, and a ratio of the number of burned-down houses to the number of survey target houses is 14%. The estimation 122 includes a circle graph showing the number of these houses, and showing 14% corresponding to the burned-down houses in red and the other 86% in a color other than red.

The situation grasping information may be displayed on the display 16C.

[Notification to Fire Station Having Jurisdiction]

The burned-down house information notification unit 40 may notify the fire station having jurisdiction over each block of at least a part of the disaster information for each block.

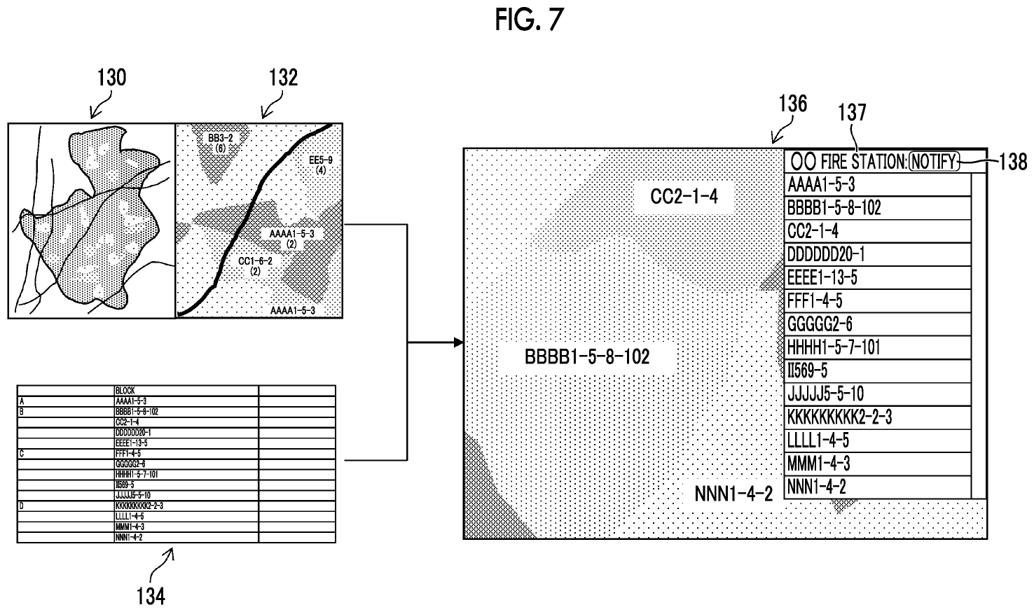

FIG. 7 is a process diagram of processing of giving a notification to the fire station having jurisdiction. FIG. 7 shows a totalization result 130 and a totalization result 132 for each block, and fire station information 134 having jurisdiction over each block.

The totalization results 130 and 132 are the same as the totalization results 114 and 116 shown in FIG. 6. In addition, in the fire station information 134, the name of the block and the fire station having jurisdiction over the block are associated with each other.

In addition, FIG. 7 shows an address list 136 of the block selected on the map. The address list 136 is the same as the address list 118 shown in FIG. 6. The burned-down house information display unit 38 displays the block (an example of an “area”) desired by the user to be selectable on the display 14C, and displays the address list 136 of the block selected by the user on the display 14C.

In addition, the burned-down house information display unit 38 acquires information on the fire station having jurisdiction over each block from the fire station information 134, automatically allocates a fire station in charge of each block, and displays the fire station in charge. In the example shown in FIG. 7, a name 137 of the fire station having jurisdiction over the block of the address list 136 and a button 138 for notifying the fire station of the disaster information are displayed at the upper part of the address list 136. In a case in which the user clicks the button 138 using a pointing device (not shown) or the like, the burned-down house information notification unit 40 notifies the fire station terminal 16 of the fire station of the name 137 of the disaster information included in the block.

[Sorting of Disaster Cause Other than Fire and Collapse]

Up to this point, an example is described in which the disaster types are sorted into three types which are fire, collapse, and others. However, it is also possible to perform sorting into another disaster type.

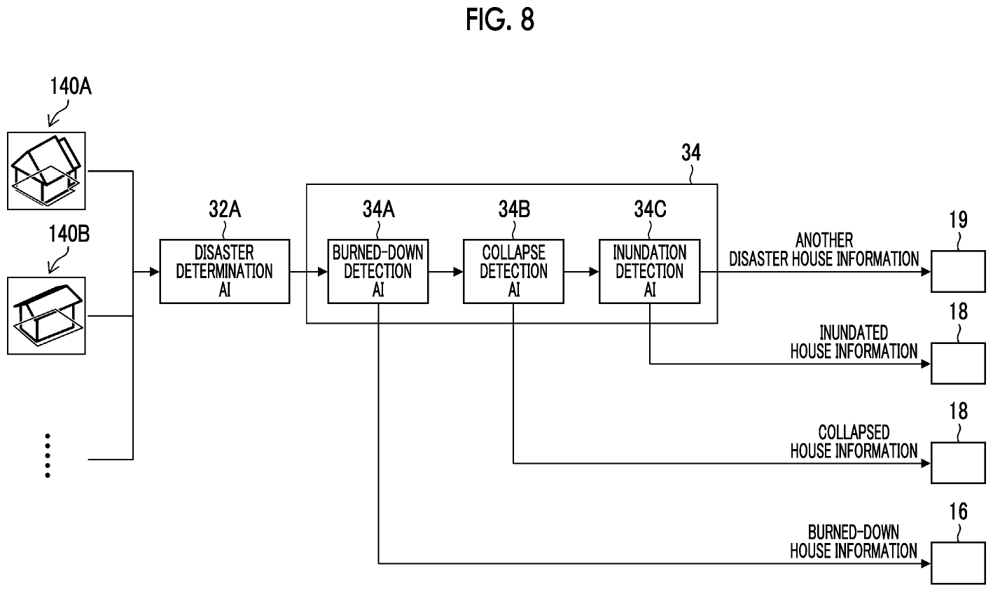

FIG. 8 is a process diagram of processing in a case in which the burned-down house due to the fire, the collapsed house due to shaking, and an inundated house due to the inland flood coexist due to the occurrence of the earthquake disaster. Here, the disaster type sorting unit 34 comprises the burned-down detection AI 34A, the collapse detection AI 34B, and an inundation detection AI 34C, and sorts the burned-down house, the collapsed house, the inundated house, and other disaster houses.

The inundation detection AI 34C is a trained model that outputs whether or not the house included in the house cutout image is inundated in a case in which the house cutout image is given as input. The fact that the house is inundated is not limited to a case of “above-floor inundation” in which the upper side of the floor of the house is inundated, and includes “under-floor inundation” in which the lower side of the floor is inundated. The inundation detection AI 34C is subjected to machine learning using a training data set for training including the house cutout image in which the region of the house is cut out and the presence or absence of the inundation of the house included in the house cutout image as a set.

FIG. 8 shows an example in which house cutout images 140A, 140B, . . . are input to the disaster determination AI 32A. The disaster determination AI 32A determines whether or not the house included in each house cutout image has suffered from a disaster.

The house cutout image in which it is determined by the disaster determination AI 32A that the house included in the house cutout image has suffered from a disaster is input to the disaster type sorting unit 34. The disaster type sorting unit 34 inputs the house cutout image in which it is determined by the disaster determination unit 32 that the house has suffered from a disaster to the burned-down detection AI 34A, and determines whether or not the house included in each of the house cutout images is burned down.

In addition, the disaster type sorting unit 34 inputs the house cutout images in which it is determined by the disaster determination unit 32 that the house has suffered from a disaster and it is determined by the burned-down detection AI 34A that the house is not burned down among the plurality of house cutout images to the collapse detection AI 34B, and determines whether or not the house included in the house cutout image is collapsed.

Further, the disaster type sorting unit 34 inputs the house cutout images in which it is determined by the disaster determination unit 32 that the house has suffered from a disaster, it is determined by the burned-down detection AI 34A that the house is not burned down, and it is determined by the collapse detection AI 34B that the house is not collapsed among the plurality of house cutout images to the inundation detection AI 34C, and determines whether or not the house included in the house cutout image is inundated.

That is, in the disaster type sorting unit 34, among the plurality of house cutout images in which the house has suffered from a disaster, the house cutout image in which the house is burned down, the house cutout image in which the house is collapsed, the house cutout image in which the house is inundated, and the house cutout image of the disaster other than burning down, the collapse, and the inundation can be sorted.

In the example shown in FIG. 8, the notification of the burned-down house information is given to the fire station terminal 16, the notifications of the collapsed house information and the inundated house information indicating that the house is inundated are given to the local government terminal 18, and the notification of another disaster house information is given to another terminal 19. The local government terminal 18 and another terminal 19 are examples of a “third terminal associated with each disaster cause”.

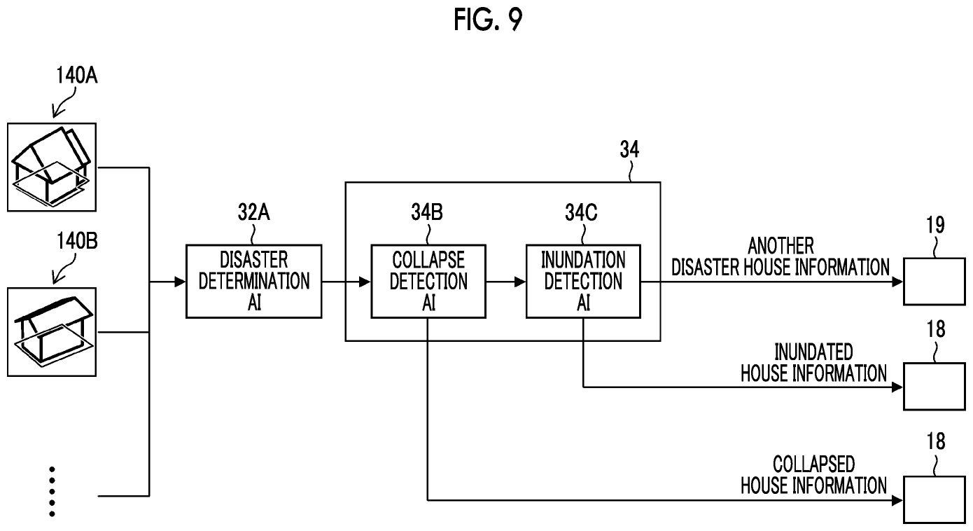

FIG. 9 is a process diagram of processing in a case in which the collapsed house due to a storm and the inundated house due to river flood or the inland flood coexist due to the occurrence of the wind and flood disaster. Here, the disaster type sorting unit 34 comprises the collapse detection AI 34B and the inundation detection AI 34C, and sorts the collapsed house and the inundated house.

In this way, the disaster information processing system 10 can sort the disaster types according to the disaster situation, and provide the disaster information to the terminal of the organization having jurisdiction over each disaster type.

[Others]

Here, an example is described in which the aerial image obtained by imaging the disaster situation from the sky over the city by using camera 12C mounted on the drone 12 is used as the high-altitude image, but the high-altitude image may be an image captured by a fixed-point camera installed in the city or a surveillance camera. Also, the high-altitude image may be a satellite image captured by a stationary satellite (an example of an “artificial satellite”).

The technical scope of the present invention is not limited to the range described in the above-described embodiment. The configurations and the like in each embodiment can be appropriately combined between the respective embodiments without departing from the gist of the present invention.

### EXPLANATION OF REFERENCES

10: disaster information processing system
12: drone
12A: processor
12B: memory
12C: camera
12D: communication interface
14: local government server
14A: processor
14B: memory
14C: display
14D: communication interface
16: fire station terminal
16A: processor
16B: memory
16C: display
16D: communication interface
18: local government terminal
19: another terminal
20: communication network
30: house detection unit
32: disaster determination unit
32A: disaster determination AI
34: disaster type sorting unit
34A: burned-down detection AI
34B: collapse detection AI
34C: inundation detection AI
36: burned-down house totalization unit
38: burned-down house information display unit
40: burned-down house information notification unit
100: high-altitude image
102: house region information
104: composite image
106A: house cutout image
106B: house cutout image
110: burned-down house information
112: block region information
114: totalization result
116: totalization result
118: address list
120: house cutout image
134: fire station information
136: address list
137: name
138: button
140A: house cutout image
140B: house cutout image
S1 to S4: each step of disaster information processing method

What is claimed is:

1. A disaster information processing apparatus comprising:
at least one processor; and
at least one memory that stores a command to be executed by the at least one processor,
wherein the at least one processor
acquires an image including a building,
extracts a first disaster building that has suffered from a disaster due to a first disaster cause from the acquired image,
calculates the number of the extracted first disaster buildings, and
provides at least a part of first disaster information, which is related to the extracted first disaster building and includes the calculated number of the first disaster buildings, to a first terminal associated with the first disaster cause.

2. The disaster information processing apparatus according to claim 1,
wherein the at least one processor
calculates the number of the extracted first disaster buildings for each area, and
provides at least a part of the first disaster information for each area, which includes the number of the first disaster buildings calculated for each area to the first terminal.

3. The disaster information processing apparatus according to claim 2,
wherein the at least one processor
acquires information on the first terminal for each area, which is associated with the first disaster cause, and
provides at least a part of the first disaster information for each area to the first terminal associated with each area.

4. The disaster information processing apparatus according to claim 2,
wherein the at least one processor
displays the area on a display to be selectable by a user, and
provides at least a part of the first disaster information on the area selected by the user to the first terminal associated with the area selected by the user.

5. The disaster information processing apparatus according to claim 2,
wherein the at least one processor
acquires area region information corresponding to the acquired image, and
acquires the first disaster information for each area by using the acquired area region information.

6. The disaster information processing apparatus according to claim 1,
wherein the at least one processor displays at least a part of the first disaster information on a display.

7. The disaster information processing apparatus according to claim 1,
wherein the at least one processor
acquires building region information corresponding to the acquired image, and
extracts the building from the acquired image by using the acquired building region information.

8. The disaster information processing apparatus according to claim 1,
wherein the at least one processor
cuts out an image of a region of the building from the image, and
discriminates whether or not the building of the cut out image is the first disaster building by inputting the cut out image of the region of the building to a first trained model, and
the first trained model outputs, in a case in which the image of the building is given as input, whether or not a disaster cause of the building of the input image is the first disaster cause.

9. The disaster information processing apparatus according to claim 1,
wherein a second disaster building that has suffered from a disaster due to a second disaster cause different from the first disaster cause is extracted from the acquired image,
the number of the extracted second disaster buildings is calculated, and
at least a part of second disaster information, which is related to the extracted second disaster building and includes the calculated number of the second disaster buildings, is provided to a second terminal associated with the second disaster cause.

10. The disaster information processing apparatus according to claim 1,
wherein the at least one processor
extracts each of disaster buildings that have suffered from a disaster due to each of a plurality of disaster causes from the acquired image,
calculates the number of the extracted disaster buildings for each disaster cause, and
provides at least a part of disaster information for each disaster cause, which is related to the extracted disaster building and includes the calculated number of the disaster buildings for each disaster cause, to a third terminal which is different from the first terminal and is associated with each disaster cause.

11. The disaster information processing apparatus according to claim 10,
wherein the at least one processor
discriminates whether or not the building included in the image has suffered from a disaster, and
extracts the disaster building that has suffered from a disaster due to each disaster cause from the building discriminated as having suffered from a disaster.

12. The disaster information processing apparatus according to claim 11,
wherein the at least one processor
cuts out an image of a region of the building from the image, and
acquires whether or not the building of the cut out image has suffered from a disaster by inputting the cut out image of the region of the building to a second trained model, and
the second trained model outputs, in a case in which the image of the building is given as input, whether or not the building of the input image has suffered from a disaster.

13. The disaster information processing apparatus according to claim 1,
wherein the first disaster cause is a fire, and
the first terminal is associated with a fire station.

14. The disaster information processing apparatus according to claim 1,
wherein the image is an aerial image captured from a flying object or a satellite image captured from an artificial satellite.

15. A disaster information processing system comprising:
a first terminal including at least one first processor, and at least one first memory that stores a command to be executed by the at least one first processor;
a server including at least one second processor, and at least one second memory that stores a command to be executed by the at least one second processor; and
a fourth terminal including at least one third processor, and at least one third memory that stores a command to be executed by the at least one third processor,
wherein the at least one third processor
acquires an image including an building,
extracts an image of a region of the building from the acquired image, and
provides the extracted image of the region of the building to the server,
the at least one second processor
acquires the image of the region of the building provided from the fourth terminal,
extracts a first disaster building that has suffered from a disaster due to a first disaster cause from the acquired image of the region of the building,
calculates the number of the extracted first disaster buildings, and
provides at least a part of first disaster information, which is related to the extracted first disaster building and includes the calculated number of the first disaster buildings, to the first terminal, and
the at least one first processor
acquires at least a part of the first disaster information provided from the server, and
displays at least a part of the first disaster information on a first display.

16. A disaster information processing method comprising:
an image acquisition step of acquiring an image including a building;
a first disaster building extraction step of extracting a first disaster building that has suffered from a disaster due to a first disaster cause from the acquired image;
a calculation step of calculating the number of the extracted first disaster buildings; and
a providing step of providing at least a part of first disaster information, which is related to the extracted first disaster building and includes the calculated number of the first disaster buildings, to a first terminal associated with the first disaster cause.

17. A non-transitory, computer-readable tangible recording medium on which a program for causing, when read by a computer, the computer to execute the disaster information processing method according to claim 16 is recorded.
